(19) United States
(12) Patent Application Publication
(10) Pub. No.: US 2004/0214067 A1
(43) Pub. Date: Oct. 28, 2004

(54) Assembling sub-stacks of electrochemical cells

(76) Inventors: Chris Boyer, Houston, TX (US); James Layton, Bryan, TX (US); James Evans, College Station, TX (US); Brad Fiebig, Bryan, TX (US)

Correspondence Address: STREETS & STEELE, 13831 NORTHWEST FREEWAY, SUITE 355, HOUSTON, TX, 77040, US

(21) Appl. No.: 10/727,796

(22) Filed: Dec. 4, 2003

Related U.S. Application Data
(60) Provisional application No. 60/431,006, filed on Dec. 4, 2002.

(51) Int. Cl. H01M 8/24; H01M 8/04

(52) U.S. Cl. 429/34; 429/26

(57) ABSTRACT

A method for assembling fully functional sub-stacks of electrochemical cells, that includes securing a plurality of electrochemical cell components into a functioning sub-stack. The cell components may include, without limitation, bipolar plates, bipolar grids, monopolar plates, monopolar grids, membrane and electrode assemblies (MEA), gas diffusion elements, flow fields, cooling plates, heating plates and combinations thereof. Each of these components are assembled in a generally planar assembly, or a stack. The method further includes banding perimeter tabs of one component in the sub-stack to perimeter tabs of another component in the sub-stack. Banding the perimeter tabs does not compress the components together with such a force as to form fluid tight seals, but rather provides compression to hold each component in place and aligned during storage and normal handling of the sub-stack. The perimeter tabs extend from the perimeter of the component and in the same plane as the component.

This application claims priority to U.S. Provisional Patent Application No. 60/431,006 filed on Dec. 4, 2002.

### BACKGROUND OF THE INVENTION

1. Field of the Invention

This invention relates to methods for assembling electrochemical cell stacks, and more particularly to methods for assembling and testing sub-stacks.

2. Description of the Related Art

Conventional construction of fuel cell and electrolyzer stacks, especially proton exchange membrane (PEM) stacks, requires a large number of substantially flat or planar components, including bipolar plates, membrane and electrode assemblies, and optionally, cooling plates, to be assembled between a pair of heavy metal endplates. A membrane and electrode assembly (MEA) comprises an anode electrode and a cathode electrode attached to opposite sides of a solid polymer electrolyte. The entire assembly is placed in compression, much like a filter press, through the use of a series of long rods, often called tie rods and typically being threaded metal rods, extending from one endplate of the assembly to the other endplate with nuts or other fasteners on either end. The compression forces exerted through the tie rods normally compress a gasket, o-ring or similar device that is inserted between the sealing surfaces, thereby sealing any gases or liquids inside the electrochemical cell stack.

An electrochemical cell stack typically has a number of planar components including the electrodes, which are normally attached to proton exchange membranes, and components that provide flow paths for the reactant fluids, any cooling fluids, and the electrons and protons that are consumed or liberated during the electrochemical reactions. Each of the fluid streams must remain separated from the other fluid streams as well as remain tightly sealed within the electrochemical cell stack so as not to leak to the outside environment. Fluid streams are typically transported to and from each cell through manifolds.

Electrochemical cell stacks may be assembled using bipolar grids or bipolar plates. Bipolar grids are used in a monopolar electrochemical stack and are described by Cisar et al. in U.S. Pat. No. 6,024,228, which is hereby fully incorporated by reference. Bipolar plates and current collectors are used in bipolar electrochemical stacks and, as used in the present invention, are described by Cisar et al. in U.S. Pat. No. 6,232,010, which is hereby fully incorporated by reference. Bipolar grids and bipolar plates are bipolar elements.

An electrochemical cell stack has a series of membrane and electrode assemblies connected in series to each other and separated by bipolar elements. A membrane and electrode assembly comprises an anode electrode and a cathode electrode attached to opposite sides of a solid polymer electrolyte. The bipolar elements prevent the reactant fluids, which are flowing over the anode and the cathode electrodes of adjacent cells, from mixing.

Assembly of electrochemical cell stacks can be time consuming and difficult. It is necessary during assembly to ensure that all components are properly aligned so that, for example, surfaces are properly compressed against each other to ensure electrical communication as required and manifolds are properly aligned to ensure fluid communication as required. It is wasteful to complete the assembly process, only to discover that a particular cell in the stack is not working efficiently because, for example, the cell's components are not properly aligned or the electrode is not properly assembled. In that case, the entire stack must be disassembled, repaired and then re-assembled.

There is a need for a method or system for assembling electrochemical cell stacks more efficiently. It would be an advantage if such a method provided for testing parts of the electrochemical cell stack before the entire stack is assembled so that any problems may be found before an entire electrochemical cell stack is fully assembled.

### SUMMARY OF THE INVENTION

The present invention provides a method having steps that include securing a first plurality of electrochemical cell components into a first functioning sub-stack and a second plurality of electrochemical cell components into a second functioning sub-stack, the first and second functioning sub-stacks each having ends terminating in a structural component selected from a bipolar plate, a cooling fluid flowfield, and combinations thereof, and then securing the first and second sub-stacks together. The method may further include the step of testing the first and second functioning sub-stacks before securing the first and second functioning sub-stacks. Testing the sub-stacks may include measuring the electrical resistance through the sub-stack and may further include leak-testing the sub-stack.

The plurality of electrochemical cell components are selected from bipolar plates, bipolar grids, monopolar plates, monopolar grids, membrane and electrode assemblies, cooling plates, heating plates, and combinations thereof.

The step of securing components into a functioning sub-stack may include banding a first perimeter tab of a first component in the sub-stack to a first perimeter tab of another component in the sub-stack and may further include banding a second perimeter tab of the first component in the sub-stack to a second perimeter tab of the other component in the sub-stack.

The first and second functioning sub-stacks may be configured as an electrochemical device selected from a fuel cell, electrolyzer, oxygen concentrator, and combinations thereof. Furthermore, the first and second functioning sub-stacks include an ionically conducting medium, which may be a solid or a liquid. The medium may be selected from, for example, a proton exchange membrane, an alkaline electrolyte, and a solid oxide electrolyte.

The present invention further provides an electrochemical sub-stack comprising electrochemical cell components assembled in a given order and alignment as required to form a functional sub-stack, and two or more perimeter tabs extending from the components located at each end of the sub-stack, wherein the two or more perimeter tabs are aligned to establish alignment of the components. Two or more perimeter tabs may extend from one or more of the components between the end components, wherein the tabs at each location on the perimeter are aligned with the tabs on the end components. The components between the end components are selected from, for example, a gas barrier, a bipolar plate, a monopolar plate, an end plate, a flow field, a membrane and electrode assembly, an electrode, electrocatalysts, a diffusion layer, and combinations thereof. The end components may be selected from, for example, a gas barrier, a bipolar plate, a monopolar plate, an end plate, a flow field and combinations thereof.

The sub-stack of the present invention may further comprise means for the securing the perimeter tabs of one end component with the perimeter tabs of the second end component, wherein securing the tabs holds the components securely together in the order and alignment. The means may be selected from, for example, wire, string, rubber bands, rope, clamps and combinations thereof.

If there are three or more perimeter tabs, optionally the perimeter tabs may be arranged asymmetrically around the perimeter. As a further option, the perimeter tabs around the perimeter of the end component and the components between the end components may be different in a way selected from color, shape, design, marking, thickness and combinations thereof, to better help align the components during the assembly process.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is an exploded view of a sub-stack in accordance with the present invention.

### DETAILED DESCRIPTION

The present invention provides a method for assembling fully functional sub-stacks of electrochemical cells, which may later be incorporated into an electrochemical cell stack. An advantage of the method is that each of the sub-stacks may be individually tested and then stored until needed for the assembly of an electrochemical cell stack. This testing allows problems to be discovered and corrected before an entire electrochemical stack is assembled and tested.

The method of the present invention includes securing a plurality of electrochemical cell components into a functioning sub-stack. The cell components may include, without limitation, bipolar plates, bipolar grids, monopolar plates, monopolar grids, membrane and electrode assemblies (MEA), gas diffusion elements, flow fields, cooling plates, heating plates and combinations thereof. Each of these components are assembled in a generally planar assembly, or a stack.

Preferably, the sub-assemblies do not have any portion of an MEA, gas diffusion layer electrocatalyst or other fragile component exposed. Typically, such components are easily damaged upon contact with other objects. For example, an MEA comprises a solid polymer electrolyte membrane having a cathode electrode formed on a first side of the membrane and an anode electrode formed on a second side of the membrane. The membrane is easily punctured or torn and, therefore, should be protected within a sub-stack and not exposed at the end of a sub-stack. Therefore, each sub-stack preferably has a component at each end that is hard, such as, for example, one made of metal or a conductive polymer. The components at the end of the sub-stack can then protect the more fragile components, such as an MEA, electrode or gas diffusion layer, that are aligned between the end components. The end components may be selected from, for example, a bipolar plate, a fluid barrier, a cooling fluid flow field, a heating fluid flow field, and combinations thereof. If the sub-stack comprises anode or cathode flow fields that are made of a hard material, such as metal or conductive polymer, the sub-stack may end with an anode or cathode flow field.

Each component of the sub-stack must be bonded or otherwise held in place through the testing step and through the period that the sub-stack is being stored until the sub-stack becomes part of an electrochemical cell stack. One method of bonding the components together is to use adhesives. Use of adhesives for assembling components of an electrochemical cell stack and sub-assemblies is fully disclosed in the U.S. Provisional Patent Application mailed to the U.S.P.T.O on Dec. 4, 2002 with Express Mail Certificate EV183625441US, which is herein fully incorporated by reference. One method of the present invention includes banding perimeter tabs of one component in the sub-stack to perimeter tabs of another component in the sub-stack. The banding of perimeter tabs does not compress the components together with such a force as to form fluid tight seals, but rather provides enough compression to hold each component in place and properly aligned during storage and normal handling of the sub-stack.

The perimeter tabs are tabs that extend from the perimeter of the component and in the same plane as the component. Optionally, these tabs may be machined into the component or bonded to the component by methods such as welding, brazing or soldering. If the component is a molded component, then the tabs may be formed during the molding process. The tabs may be banded together using wire, string, rubber bands, rope, clamps or combinations thereof.

Two or more sub-stacks may also be banded together by banding the perimeter tabs extending from the components of one sub-stack to the perimeter tabs extending from the components of another sub-stack.

The tabs may also be used to properly align the different components to each other during assembly of the sub-stack. If the tabs are placed at the same location for each component in the sub-stack, then the perimeter tabs will be aligned when the components are properly aligned. Aligning the tabs on each component is a simple process and assures that all the components are properly aligned, both laterally and radially, when all the tabs are properly aligned. Optionally, tabs may have different shapes or different colors around the perimeter of the components to further provide a means for properly aligning the components during assembly of the sub-stacks. If the tabs are different, then the components are further constrained in the number of ways they may be aligned by just aligning the tabs. Arranging the tabs asymmetrically around the perimeter is another way to help assure proper alignment of the components in the sub-stack.

Placing one or more of the sub-stacks between two temporary endplates and compressing the sub-stacks therebetween prepares the sub-stacks for testing. If additional components are required to form a working electrochemical cell stack, then those components may also be included in the test stack. The endplates include connections to the reactant and cooling sources and align with the manifolds contained in the sub-stacks. Likewise, the endplates include connections for the manifolds in the sub-stacks that remove products and unreacted fluids from the electrochemical cells or that circulate a cooling or heating fluid through the cell as, for example, through a fluid cooled bipolar plate.

During the testing process, the sub-stacks may be operated over a range of reactant flow rates and temperatures and varying voltage and current flows. The testing procedure includes measuring the electrical resistance through the sub-stack and further includes leak-testing the sub-stack. These testing techniques and others are well known to those having ordinary skill in the art.

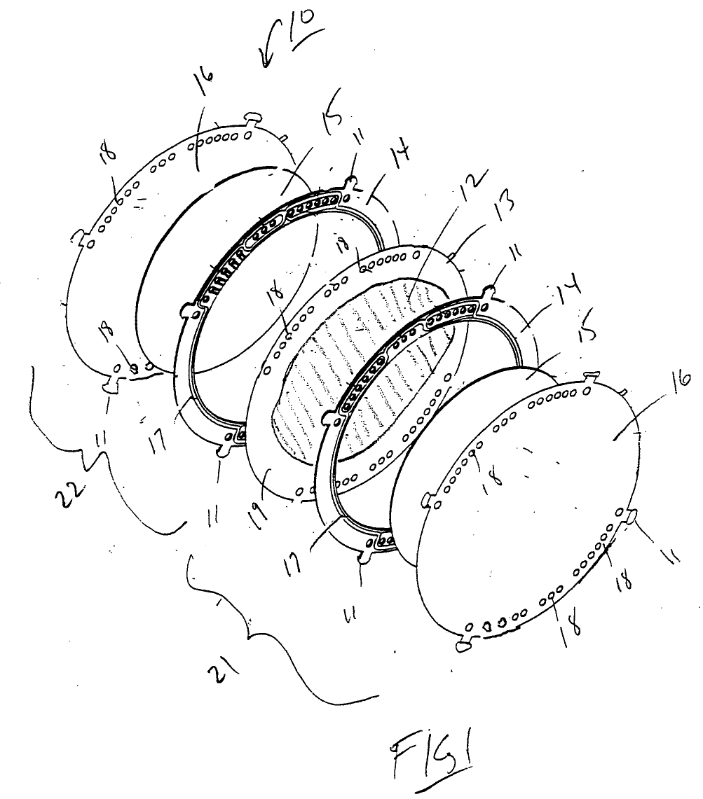

FIG. 1 is an exploded view of a sub-stack made in accordance with the present invention. The sub-stack 10 is assembled with several different components including a membrane and electrode assembly (MEA) 13 having an electrocatalyst 12 disposed on each side of the MEA 13. The MEA 13 separates the anode side 22 from the cathode side 21 of the exemplary sub-assembly 10. The anode side 22 and the cathode side 21 each comprise a frame 14 that surrounds a flow field 15 and a gas separator 16. The gas separator 16 is a solid, conductive material, such as metal, and provides a suitable end component for each end of the sub-stack 10. Sealing materials 17 are provided between the components to form fluid tight seals. The sealing materials may be gaskets, o-rings or integral seals that are formed on the sealing surfaces of the components. Manifolds 18 carry fluids, such as reactant fluids, product fluids and heating or cooling fluids, to and from the flow fields 15.

Each of the frames 14 and gas barriers 16 have perimeter tabs 11. The perimeter tabs may be used to align these components during the assembly of the sub-stack 10. Furthermore, by checking the perimeter tabs 11 after assembly of the sub-stack 10, it is easy to determine if a component has been moved out of the proper alignment by observing that some of the perimeter tabs 11 are no longer properly aligned.

The MEA 13 has no perimeter tabs because the membrane 19 extends into the area of the sealing surfaces having the sealing material 17, and the MEA is not mounted on a separate frame. Alternatively, the MEA could be mounted on a separate frame having sealing surfaces and perimeter tabs. The membrane 19 of the MEA 13 provides a suitable material for creating a fluid tight seal because the membrane 19, typically a perfluoronated sulphonic acid polymer, has sufficient compressibility.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

What is claimed is:

1. A method, comprising:
securing a first plurality of electrochemical cell components into a first functioning sub-stack and a second plurality of electrochemical cell components into a second functioning sub-stack, the first and second functioning sub-stacks each having ends terminating in a structural component selected from a bipolar plate, a cooling fluid flowfield, and combinations thereof; and then
securing the first and second sub-stacks together.

2. The method of claim 1, further comprising:
testing the first and second functioning sub-stacks before securing the first and second functioning sub-stacks.

3. The method of claim 1, wherein the plurality of electrochemical cell components are selected from bipolar plates, bipolar grids, monopolar plates, monopolar grids, membrane and electrode assemblies, cooling plates, heating plates, and combinations thereof.

4. The method of claim 2, wherein the testing comprises measuring the electrical resistance through the sub-stack.

5. The method of claim 2, wherein the testing comprises leak-testing the sub-stack.

6. The method of claim 1, wherein the step of securing components into a functioning sub-stack includes banding a first perimeter tab of a first component in the sub-stack to a first perimeter tab of another component in the sub-stack.

7. The method of claim 5, wherein the step of securing components into a functioning sub-stack includes banding a second perimeter tab of the first component in the sub-stack to a second perimeter tab of the other component in the sub-stack.

8. The method of claim 1, wherein the first and second functioning sub-stacks are configured as an electrochemical device selected from a fuel cell, electrolyzer, oxygen concentrator, and combinations thereof.

9. The method of claim 1, wherein the first and second functioning sub-stacks include an ionically conducting medium.

10. The method of claim 8, wherein the medium is selected from a solid and a liquid.

11. The method of claim 8, wherein the medium is selected from a proton exchange membrane, an alkaline electrolyte, and a solid oxide electrolyte.

12. An electrochemical sub-stack, comprising:
electrochemical cell components assembled in a given order and alignment as required to form a functional sub-stack; and
two or more perimeter tabs extending from the components located at each end of the sub-stack, wherein the two or more perimeter tabs are aligned to establish alignment of the components.

13. The sub-stack of claim 12, further comprising:
two or more perimeter tabs extending from one of more of the components between the end components, wherein the tabs at each location on the perimeter are aligned with the tabs on the end components.

14. The sub-stack of claim 13, wherein the components between the end components are selected from a gas barrier, a bipolar plate, a monopolar plate, an end plate, a flow field, a membrane and electrode assembly, an electrode, electrocatalysts, a diffusion layer, and combinations thereof.

15. The sub-stack of claim 12, wherein the end components are selected from a gas barrier, a bipolar plate, a monopolar plate, an end plate, a flow field and combinations thereof

16. The sub-stack of claim 12, further comprising:
means for the securing the perimeter tabs of one end component with the perimeter tabs of the second end component, wherein securing the tabs holds the components securely together in the order and alignment.

17. The sub-stack of claim 16, wherein the means is selected from wire, string, rubber bands, rope, clamps and combinations thereof.

18. The sub-stack of claim 12, wherein there are three or more perimeter tabs, the perimeter tabs are arranged asymmetrically around the perimeter.

19. The sub-stack of claim 12, wherein each of the perimeter tabs around the perimeter of the end component are different in a way selected from color, shape, design, marking, thickness and combinations thereof.
